(19) United States
(12) Patent Application Publication
(10) Pub. No.: US 2013/0195473 A1
(43) Pub. Date: Aug. 1, 2013

(54) PRINTING APPARATUS, CONTROL METHOD FOR PRINTING APPARATUS, AND STORAGE MEDIUM

(71) Applicant: CANON KABUSHIKI KAISHA, Tokyo (JP)

(72) Inventor: Toru Sakaguchi, Inagi-shi (JP)

(73) Assignee: CANON KABUSHIKI KAISHA, Tokyo (JP)

(21) Appl. No.: 13/753,372

(22) Filed: Jan. 29, 2013

(30) Foreign Application Priority Data
Jan. 31, 2012 (JP) 2012-018097

(51) Int. Cl. G03G 15/00

(52) U.S. Cl. CPC G03G 15/70
USPC 399/18

(57) ABSTRACT

A printing apparatus is capable of controlling an anti-jam mode for two-sided printing to an optimal level according to each printing. A method for controlling a printing apparatus configured to print an image on a sheet includes fixing the image on the sheet at a first fixing temperature by a fixing unit, determining whether a sheet jam caused by the fixing unit has occurred, and controlling a temperature of the fixing unit such that the temperature is reduced from the first fixing temperature to a second fixing temperature lower than the first fixing temperature, when the sheet jam caused by the fixing unit is determined to have occurred.

### BACKGROUND OF THE INVENTION

1. Field of the Invention

The present invention relates to a printing apparatus capable of printing images on two sides of a sheet, a control method for the printing apparatus, and a storage medium.

2. Description of the Related Art

Conventionally, among printing apparatuses, such as a laser beam printer, for printing an image with toner, when two-sided printing is performed, there are some printing apparatuses in which a fixing and discharging delay jam tends to occur in a fixing area at the time of second-side printing. Herein, a curl of the sheet, which may be formed when the first side of the sheet undergoes printing, may be a cause of the fixing and discharging delay jam. If the sheet is curled, the sheet is less likely to be conveyed up to a fixing unit at the time of printing of the subsequent second side.

Accordingly, reduction of a fixing temperature of the fixing unit can reduce the possibility of curling of a sheet, thereby reducing the frequency of jam occurrence.

Moreover, reduction of a transfer bias applied to a leading edge of the sheet at the time of conveyance of the sheet to the fixing unit can reduce the possibility that the leading edge of the sheet is not properly inserted into the fixing unit. However, it becomes difficult for toner to be fixed to the sheet, which causes deterioration in image quality.

With the application of these characteristics, there is a printing apparatus having an anti-jam mode for not only reducing a fixing temperature but also reducing a second-side transfer bias to be only applied to a leading end of a sheet when two-sided printing is performed. More specifically, reduction of a fixing temperature of the printing apparatus can reduce the possibility of curling of a sheet at the time of first-side printing. Moreover, a second-side transfer bias to be only applied to a leading end of the sheet is reduced when the sheet is conveyed to a fixing unit at the time of second-side printing. Such reduction of the second-side transfer bias can reduce the possibility that the leading end of the sheet is not properly inserted into the fixing unit. Therefore, the frequency of fixing and discharging delay jam occurrences at the time of second-side printing can be reduced. This anti-jam mode includes a plurality of kinds of modes for each of reduction steps of the transfer bias and the fixing temperature. A user can set a mode by manually selecting any one of the modes.

Japanese Patent Application Laid-Open No. 2008-158242 discusses a printing apparatus capable of simultaneously preventing both of conveyance failure and fixing failure due to an occurrence of curling at the time of two-sided image formation on a recording medium as a technique for preventing conveyance failure such as a jam by correcting curling of a sheet.

However, the higher the anti-jam mode effect, the lower the fixing temperature and the lower the transfer bias. Consequently, it becomes difficult for toner to be fixed to the sheet, which causes deterioration in image quality. That is, there is a trade-off relationship between the effect provided by the anti-jam mode and the image quality. Accordingly, a high-effective anti-jam mode should not be indiscriminately set. On the other hand, if a low-effective anti-jam mode is indiscriminately set, a jam may occur frequently. Therefore, an anti-jam mode can be set appropriately according to each printing.

However, in a case where a user needs to set a mode by manually selecting one of the plurality of kinds of anti-jam modes, the user has difficulty in determining which anti-jam mode is appropriate. Therefore, such a technique has a problem in which a user cannot set an appropriate anti-jam mode according to each printing.

### SUMMARY OF THE INVENTION

According to an aspect of the present invention, a printing apparatus configured to print an image on a sheet includes a fixing unit configured to fix the image on the sheet at a first fixing temperature, a first determination unit configured to determine whether a sheet jam caused by the fixing unit has occurred, and a control unit configured to control a temperature of the fixing unit such that the temperature is reduced from the first fixing temperature to a second fixing temperature lower than the first fixing temperature, when the first determination unit determines that the sheet jam caused by the fixing unit has occurred.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an example of a printing system employing a printing apparatus according to a first exemplary embodiment.

FIG. 2 is a block diagram illustrating a hardware configuration of a personal computer (PC) illustrated in FIG. 1.

FIG. 3 is a block diagram illustrating a hardware configuration of the printing apparatus illustrated in FIG. 1.

FIG. 4 is a diagram illustrating an example of a user interface (UI) screen displayed on the PC illustrated in FIG. 1.

FIG. 5 is a diagram illustrating information stored in a nonvolatile memory (NVMEM) of the printing apparatus illustrated in FIG. 1.

FIG. 6 is a flowchart illustrating a control method for the printing apparatus.

FIG. 7 is a flowchart illustrating a control method for the printing apparatus.

FIG. 8 is a flowchart illustrating a control method for the printing apparatus.

FIG. 9 is a cross-sectional view illustrating a configuration of the printing apparatus illustrated in FIG. 1.

### DESCRIPTION OF THE EMBODIMENTS

Various exemplary embodiments, features, and aspects of the invention will be described in detail below with reference to the drawings.

A printing apparatus according to a first exemplary embodiment of the present invention is described with reference to drawings. In the present exemplary embodiment, a printing apparatus performing heat fixing processing is described as an example. However, the present exemplary embodiment can be applied to, for example, a facsimile apparatus and a multifunction peripheral having multiple functions as long as an apparatus includes a printer engine for causing a developer to be fixed on a sheet by heat fixing processing.

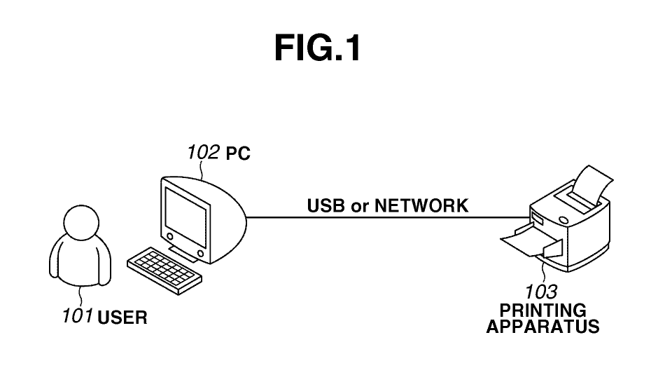

FIG. 1 is a diagram illustrating an example of a printing system employing the printing apparatus according to the present exemplary embodiment. In FIG. 1, a printing apparatus 103 is connected to a personal computer (PC) 120 via a bidirectional communication interface, for example, a universal serial bus (USB) or a network. A user 101 operates the PC 102 or an operation unit 316 of the printing apparatus 103, so that an optional setting or an instruction can be provided to the printing apparatus 103. When the user 101 operates the PC 102 for the setting, the user 101 causes the PC 102 to communicate with the printing apparatus 103 via a printer driver installed in the PC 102 to reflect the setting.

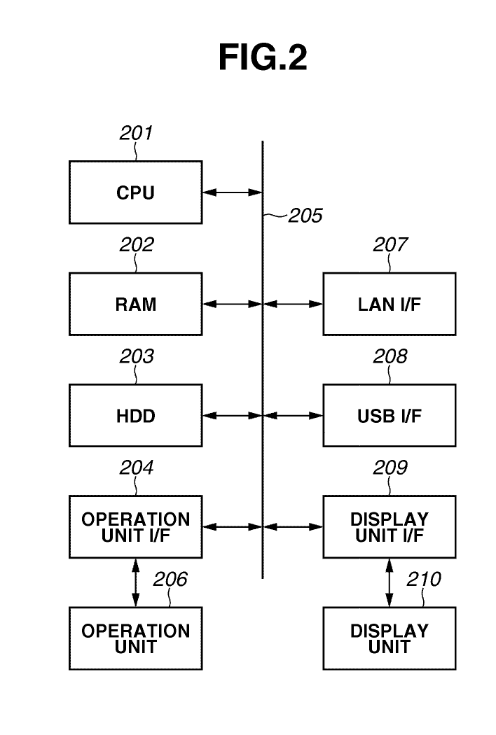

FIG. 2 is a block diagram illustrating a hardware configuration of the PC 102 illustrated in FIG. 1. In FIG. 2, a central processing unit (CPU) 201 is a processor for controlling the entire system. A random access memory (RAM) 202 is a system work memory for the CPU 201 to operate, and is used as a program memory for recording a program. A hard disk drive (HDD) 203 is used as a data storage area. An operating system (OS), and applications for executing various data processing are installed in the HDD 203. In addition, a printer driver (a print control program) for communicating with the printing apparatus 103 illustrated in FIG. 1 is installed in the HDD 203. An operation unit interface (I/F) 204 is an interface unit to an operation unit 206, and receives an input signal from the operation unit 206. Moreover, the operation unit interface 204 informs the CPU 201 of the information input from the operation unit 206 by the user.

A display unit interface (I/F) 209 is an interface unit to a display unit 210, and outputs an output signal to the display unit 210 according to control of the CPU 201. A USB interface 208 (I/F) is a function unit for connecting with a USB device. The USB interface 208 is used to acquire status of other devices via the USB, and return the status to the other devices. Moreover, the USB interface 208 is used to input and output print data. A local area network (LAN) interface 207 (I/F) is a function unit for connecting with a LAN. The LAN interface 207 is used to acquire status of other devices via the LAN, and return the status to the other devices. Moreover, the LAN interface 207 is used to input and output print data. These components are arranged on a system bus 205.

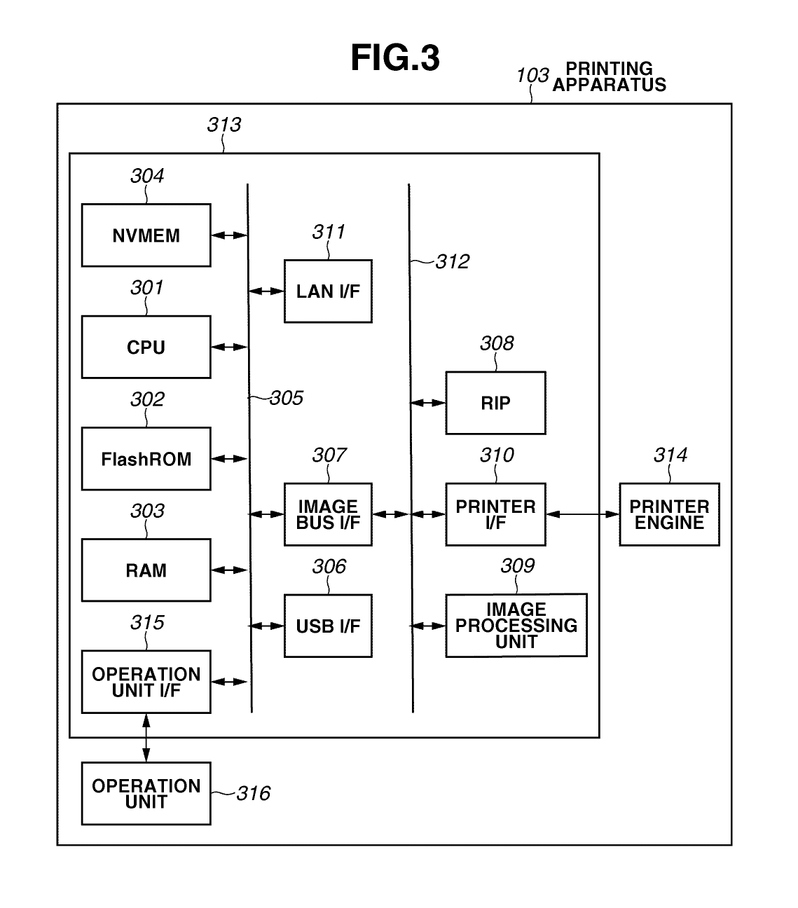

FIG. 3 is a block diagram illustrating a hardware configuration of the printing apparatus 103 illustrated in FIG. 1. In FIG. 3, a controller unit 313 is connected to a printer engine 314 functioning as an image output device, so that image data and device information are input and output between the PC 102 and the printer engine 314. The controller unit 313 is connected to the operation unit 316, so that an optional setting and an instruction from the user 101 can be received. A CPU 301 is a processor for controlling the entire system. The printer engine 314 executes print processing based on a transfer condition and a heat fixing condition according to a set mode. Herein, the print processing includes processing for causing a developer to be transferred to one side of a sheet and then fixed with heat, and processing for causing a developer to be transferred to two sides of a sheet and then fixed with heat. A RAM 303 is a system work memory for the CPU 301 to operate. Moreover, the RAM 303 serves as a program memory for recording a program, and an image memory for temporarily recording image data. A nonvolatile memory (NVMEM) 304 records setting information, for example. A flash read-only memory (ROM) 302 is a rewritable nonvolatile memory, and records various control programs for controlling the system.

An operation unit interface (I/F) 315 is an interface unit for the operation unit 316, and receives an input signal from the operation unit 316. Moreover, the operation unit interface 315 informs the CPU 301 of the information input by the user 101 from the operation unit 316. A USB interface (I/F) 306 allows USB connection to the PC 102. A LAN interface (I/F) 311 allows LAN connection to the PC 102. These components are arranged on a system bus 305.

An image bus interface (I/F) 307 is a bus bridge for connecting the system bus 305 and an image bus 312 transferring image data at high speed, and changes a data structure. The image bus 312 includes a peripheral component interconnect (PCI) bus or Institute of Electrical and Electronics Engineers (IEEE) 1394.

The following devices are arranged on the image bus 312. A raster image processor (RIP) 308 rasterizes vector data, such as a page description language (PDL) record, into a bit map image using the RAM 303. A printer interface (I/F) 310 connects the printer engine 314 and the controller unit 313, and performs synchronous/non-synchronous conversion of image data and an exchange of data. An image processing unit 309 corrects, processes, and edits input image data. The image processing unit 309 also performs printer correction and resolution conversion with respect to print output image data. In addition, the image processing unit 309 allows rotation of image data, and performs compression and decompression processing, such as joint photographic experts group (JPEG) on multivalued image data, and joint bi-level image experts group (JBIG), modified modified relative element address designate (READ) (MMR), and modified Huffman (MH) on binary image data.

The printer engine 314 converts raster image data into an image on a sheet. The printer engine 314 prints an image by electrophotographic method using a photosensitive drum and a photosensitive belt. Activation of a print operation is started with an instruction from the CPU 301.

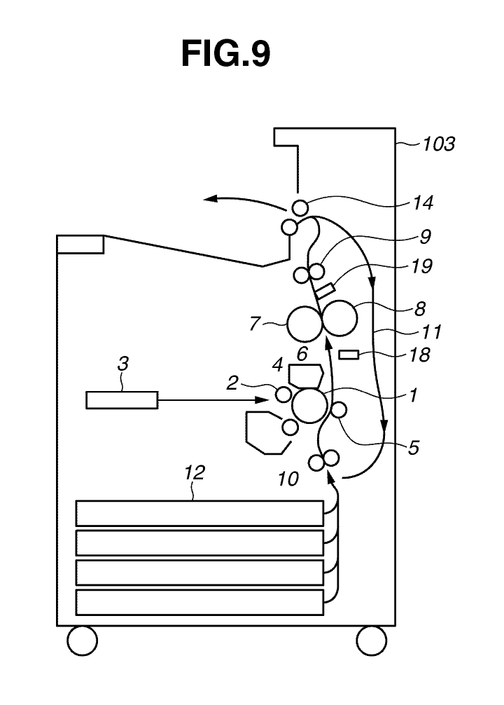

Herein, an internal configuration of the printing apparatus 103 and a print procedure are described with reference to FIG. 9. A transfer roller 5 is disposed in contact with a photosensitive drum 1 serving as an image bearing member to form a transfer nip, and transfer a toner image to a sheet by receiving a transfer bias from a bias power source (not illustrated).

The printing apparatus 103 causes a charging roller 2 to uniformly charge the photosensitive drum 1. Then, the printing apparatus 103 causes a laser generation unit 3 to expose the photosensitive drum 1 to a laser beam according to image data from an external device (e.g., the PC 102), thereby forming an electrostatic latent image on the photosensitive drum 1. Subsequently, the printing apparatus 103 causes a developing device 4 to make the electrostatic latent image visible with toner. In parallel with such processing, the printing apparatus 103 causes a sheet cassette 12 to feed a sheet to guide the sheet to the transfer nip at conveyance timing adjusted by a registration roller pair 10. The printing apparatus 103 transfers the image made visible to a first side of the sheet guided to the transfer nip, thereby forming an image. A cleaner 6 removes a residual transfer toner from the photosensitive drum 1.

The sheet having the transferred toner image is guided to a fixing device including a fixing roller 7 and a pressure roller 8, so that the toner image is fixed to the sheet. Then, the sheet is discharged on a sheet discharge tray by a fixing and discharging roller pair 9 and a discharging and reversing roller pair 14. The fixing device includes a temperature sensor (not illustrated), and the CPU 301 detects information relating to a temperature of the fixing device using this temperature sensor. When two-sided printing is performed, the sheet conveyed to the discharging and reversing roller pair 14 is switched back by the discharging and reversing roller pair 14, to be guided to a two-sided conveyance path 11 by a flapper (not illustrated). The printing apparatus 103 guides the sheet to the transfer nip again, thereby forming an image on a second side of the sheet. Subsequently, the sheet is guided to the fixing device including the fixing roller 7 and the pressure roller 8, so that a toner image is fixed to the sheet. Then, the sheet is discharged on the sheet discharge tray by the fixing and discharging roller pair 9 and the discharging and reversing roller pair 14.

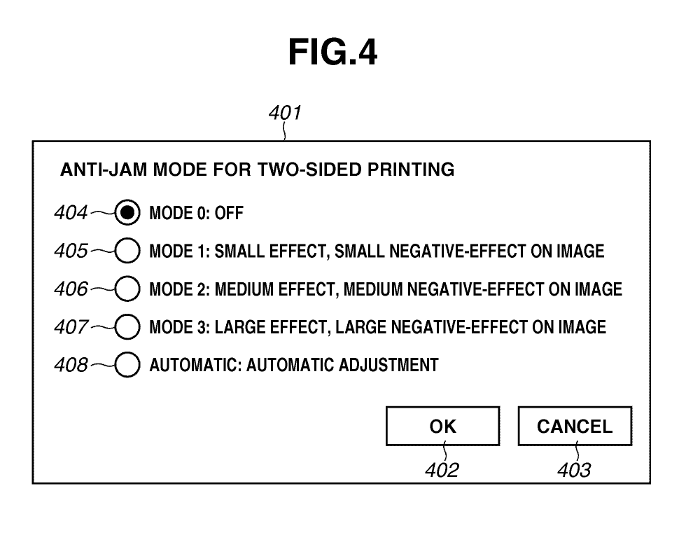

FIG. 4 is a diagram illustrating an example of a UI screen displayed on the PC 102 illustrated in FIG. 1. This diagram is an example screen of a UI application provided by the printer driver, and corresponds to an example screen for designating an anti-jam mode for two-sided printing. When the two-sided printing is performed, the user 101 executes the UI application to set the anti-jam mode for reducing a fixing temperature and a second-side transfer bias applied only to a leading end of the sheet. This UI application is manually activated by the user using the operation unit 206 of the PC 102 to perform setting for the present exemplary embodiment. In FIG. 4, a radio button 404 in a dialog 401 corresponds to mode 0 in which the anti-jam mode is not performed. Radio buttons 405, 406, and 407 correspond to mode 1, mode 2, and mode 3, respectively. The greater the mode number, the higher the anti-jam effect. A radio button 408 corresponds to automatic that is proposed by the present exemplary embodiment. This automatic is a mode for operating in an appropriate anti-jam mode corresponding to each printing.

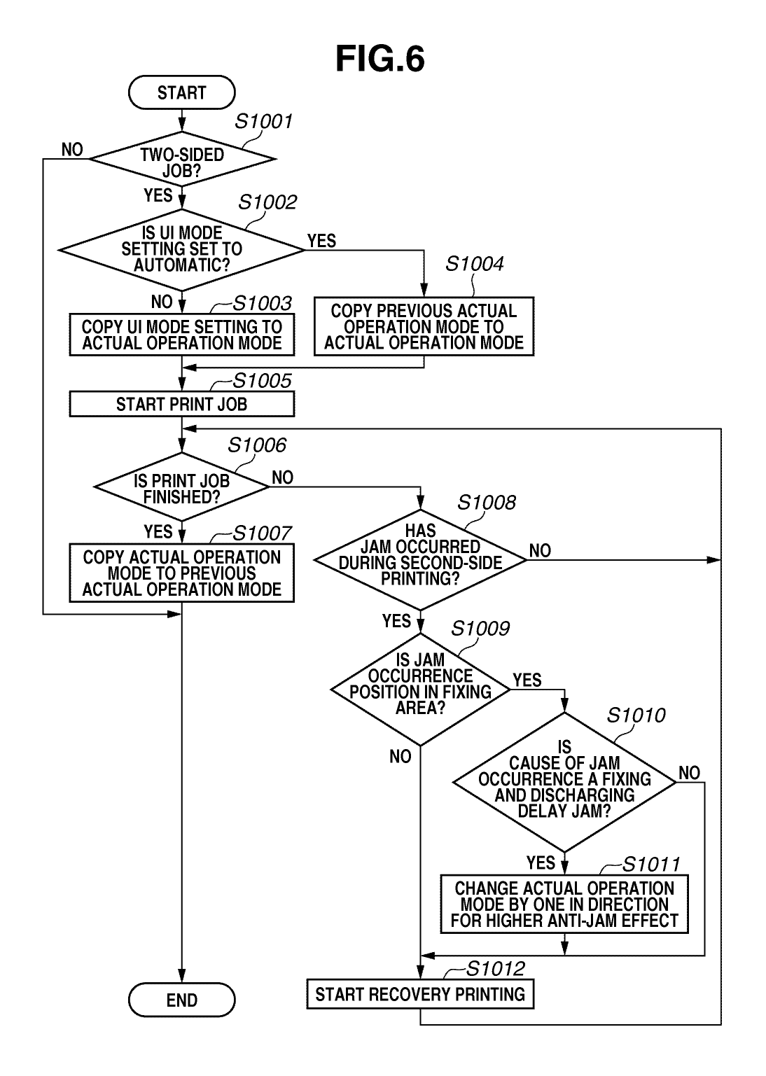

The user 101 selects one of the anti-jam modes from the mode 0, the mode 1, the mode 2, the mode 3, and the automatic using the respective radio buttons 404, 405, 406, 407, and 408. When an OK button 402 is pressed upon selection of the mode, the selected mode is set as the anti-jam mode on the UI application. In the present exemplary embodiment, a level of reducing a cause of a jam occurrence at the time of fixing of a developer transferred to the second side with heat can be increased step by step (mode 0, mode 1, mode 2, mode 3). Herein, if a mode is changed by one, a fixing temperature for fixing an image transferred to a sheet by the fixing device is reduced stepwise according to the changed level, and a transfer bias to be applied to a leading end area of the conveyed sheet is set to be reduced stepwise according to the changed level. That is, the CPU 301 executes the procedure illustrated in FIG. 6 such that a fixing temperature is set to be reduced stepwise according to the change level, and a transfer bias to a leading end area of the conveyed sheet is set to be reduced stepwise according to the changed level.

This setting is transmitted from the LAN interface 207 or the USB interface 208 of the PC 102 functioning as an information processing apparatus to the LAN interface 311 or the USB interface 306 of the printing apparatus 103, and then stored in the NVMEM 304. Herein, this setting is called a UI mode setting 501 for the sake of convenience.

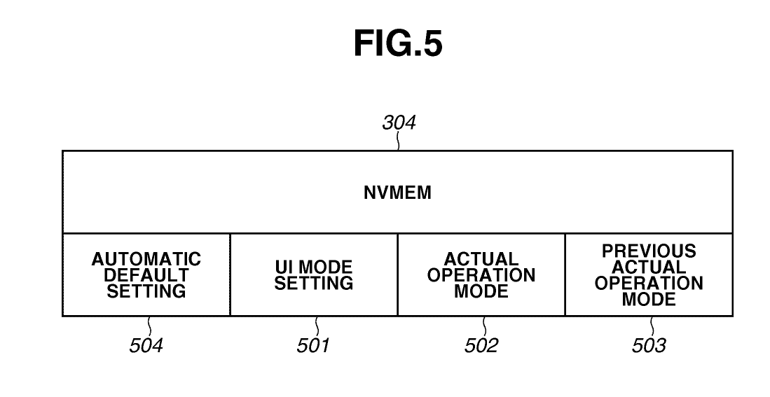

FIG. 5 is a diagram illustrating information stored in the NVMEM 304 of the printing apparatus 103 illustrated in FIG. 1. A setting and a mode related to the present exemplary embodiment are illustrated in FIG. 5. The UI mode setting 501 in FIG. 5 is described above with reference to FIG. 4. An actual operation mode 502 is a setting value of an actual anti-jam mode in operation at the time of printing. A previous actual operation mode 503 is a setting value indicating one of the anti-jam modes among the mode 0, the mode 1, the mode 2, the mode 3, and the automatic in which the printing apparatus 103 has been in operation immediately before completion of a two-sided print job. An automatic default setting 504 has a fixed setting value to be read out and copied to the previous actual operation mode 503 when a restart power source of the printing apparatus 103 is turned OFF and then ON. Particularly, when a developer transferred to a second side of a sheet is fixed with heat subsequent to print processing on a first side of the sheet, the mode 0, the mode 1, the mode 2, and the mode 3 correspond to a plurality of step modes for reducing a jam occurrence.

FIG. 6 is a flowchart illustrating a control method for the printing apparatus 103 according to the present exemplary embodiment. This flowchart illustrates an example procedure of print job processing. Each step is executed by the CPU 301 loading a control program into the RAM 303 to execute. This flow allows the printing apparatus 103 to automatically change an anti-jam mode setting for two-sided printing in a direction for higher anti-jam effect according a condition.

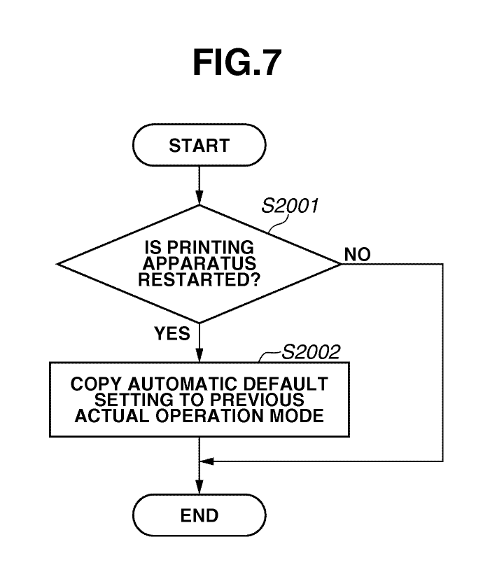

In the present exemplary embodiment, assume that, when printing for a two-sided print job is completed, the actual anti-jam mode in which the printing apparatus 103 has been in operation immediately before completion of the two-sided print job is stored in the previous actual operation mode 503. Moreover, as illustrated in FIG. 7, if a two-sided print job has not been performed yet since restart of the printing apparatus 103, the automatic default setting 504 is being stored in the previous actual operation mode 503. Accordingly, the UI mode setting 501, the previous actual operation mode 503, and the automatic default setting 504 are being stored in the NVMEM 304 of the printing apparatus 103 at the time of starting the processing illustrated in FIG. 6.

In step S1001, the CPU 301 of the printing apparatus 103 determines whether two-sided printing is designated whenever receiving a print job. If the CPU 301 determines that the two-sided printing is not designated in the received print job (NO in step S1001), this procedure ends. In this case, the printing apparatus 103 performs one-sided printing. On the other hand, if the CPU 301 determines that the two-sided printing is designated in the received print job (YES in step S1001), then in step S1002, the CPU 301 reads out the UI mode setting 501 stored in the NVMEM 304, and determines whether the UI mode setting 501 is set to automatic.

If the CPU 301 determines that the UI mode setting 501 is not set to automatic (NO in step S1002), the operation proceeds to step S1003. In step S1003, the CPU 301 reads out the UI mode setting 501 stored in the NVMEM 304, and copies the UI mode setting 501 to the actual operation mode 502. Then, in step S1005, the CPU 301 starts the print job.

On the other hand, if the CPU 301 determines that the UI mode setting 501 is set to the automatic (YES in step S1002), the operation proceeds to step S1004. In step S1004, the CPU 301 reads out the previous actual operation mode 503 stored in the NVMEM 304, and copies the previous actual operation mode 503 to the actual operation mode 502. Subsequently, in step S1005, the CPU 301 starts the received print job.

In step S1006, after printing for the print job is started, the CPU 301 determines whether printing of all the pages in the job is finished. If the CPU 301 determines that printing of all the pages in the job is finished (YES in step 1006), then in step S1007, the CPU 301 copies the actual operation mode 502 to the previous actual operation mode 503 to store the previous actual operation mode 503 in the NVMEM 304. Then, this procedure ends.

On the other hand, if the CPU 301 determines that printing for the received job is not finished (NO in step 1006), then in step S1008, the CPU 301 determines whether a jam has occurred at the time of second-side printing. In step S1008, the CPU 301 uses a plurality of sensors disposed on a sheet conveyance path of the printing apparatus 103 to detect whether a jam has occurred. The plurality of sensors detects whether there is a sheet in positions thereof. The plurality of sensors is disposed between one another with a distance shorter than a width of a sheet in a conveyance direction. For example, if a first sensor on the sheet conveyance path detects passage of a sheet, and then a second sensor does not detect passage of the sheet within a predetermined time, the CPU 301 determines that a jam has occurred. Herein, the second sensor is supposed to detect the passage of the sheet subsequent to the passage detection by the first sensor.

If the CPU 301 determines that a jam has not occurred at the time of the second-side printing (NO in step S1008), the procedure returns to step S1006. In step S1006, the CPU 301 determines whether printing of all the pages in the job is finished.

On the other hand, if the CPU 301 determines that a jam has occurred at the time of the second-side printing (YES in step S1008), then in step S1009, the CPU 301 determines whether a jam occurrence position notified by the printer engine 314 is in a fixing area. As illustrated in FIG. 9, a sensor 18 and a sensor 19 are disposed near the fixing device to detect whether a sheet is present in the sheet conveyance path. Each of the sensors 18 and 19 is included in the plurality of sensors described above. If the sensor 18 or 19 detects the sheet, the CPU 301 determines that the jam occurrence position notified from the printer engine 314 is in the fixing area (YES in step S1009). On the other hand, if neither of the sensors 18 and 19 detects a signal indicting the presence of the sheet, the CPU 301 determine that the jam occurrence position notified from the printer engine 314 is not in the fixing area (NO in step S1009).

If the CPU 301 determines that the jam occurrence position is not in the fixing area (NO in step S1009), then in step S1012, as soon as the jam is released (the jammed sheet is removed) and the printing apparatus 103 becomes ready for printing, the CPU 301 causes the printing apparatus 103 to start recovery printing. Then, the procedure returns to step S1006.

On the other hand, if the CPU 301 determines that the jam occurrence position is in the fixing area (YES in step S1009), then in step S1010, the CPU 301 determines whether a cause of the jam occurrence notified from the printer engine 314 is a fixing and discharging delay jam. The fixing and discharging delay jam includes a jam that occurs due to that a leading end of a sheet is not properly inserted into the fixing device. When a condition is satisfied in which the CPU 301 receives a signal indicating the presence of the sheet from the sensor 18, but does not receive a signal indicating the presence of the sheet from the sensor 19 within the predetermined time, the CPU 301 determines that a cause of the jam occurrence is the fixing and discharging delay jam (YES in step S1010). On the other hand, if the condition is not satisfied in spite of jam occurrence, the CPU 301 determines that a cause of the jam occurrence is not the fixing and discharging delay jam (NO in step S1010). If the CPU 301 determines that the fixing and discharging delay jam is not a cause of the jam (NO in step S1010), then in step S1012, as soon as a jam recovery procedure is performed and then the printing apparatus 103 becomes ready for printing, the CPU 301 causes the printing apparatus 103 to start recovery printing. Subsequently, the procedure returns to step S1006.

On the other hand, if the CPU 301 determines that a cause of the jam occurrence is the fixing and discharging delay jam (YES in step S1010), then in step S1011, the CPU 301 changes the actual operation mode 502 by one in a direction for higher anti-jam mode effect. In step S1012, the CPU 301 causes the printing apparatus 103 to start the recovery printing, as soon as a jam recovery procedure is performed and then the printing apparatus 103 becomes ready for printing. After starting the recovery printing (step S1012), the procedure returns to step S1006, in which the CPU 301 determines whether printing of all the pages in the job is finished. Accordingly, if the CPU 301 determines that the cause of the jam is the fixing and discharging delay, the CPU 301 changes a level of the set mode stepwise so that the print processing can continue.

FIG. 7 is a flowchart illustrating a control method for the printing apparatus 103 according to the present exemplary embodiment. This flowchart illustrates an example procedure for setting an anti-jam mode when a restart power source of the printing apparatus 103 is turned OFF and then ON. Each step is executed by the CPU 301 loading a control program into the RAM 303 to execute. This flow allows the printing apparatus 103 to change the actual operation mode 502 at the time when the UI mode setting 501 is being set to automatic to the automatic default setting 504 having a fixed setting value.

In step S2001, the CPU 301 of the printing apparatus 103 determines whether the printing apparatus 103 is restarted. If the CPU 301 determines that the printing apparatus 103 is restarted (YES in step S2001), then in step S2002, the CPU 301 reads out the automatic default setting 504 stored in the NVMEM 304 to copy the automatic default setting 504 to the previous actual operation mode 503. Subsequently, this procedure ends. If the CPU 301 determines that the printing apparatus 103 is not restarted (NO in step S2001), the procedure of this flow ends. According to the present exemplary embodiment, therefore, the printing apparatus 103 can control an anti-jam mode for two-sided printing to an optimal value according to each printing. The printing apparatus 103 controls the anti-jam mode setting value being difficult to be determined by a user to the optimal value in an automatic manner. Thus, the user does not need to concern about the mode setting, thereby the printing apparatus 103 can provide high usability. Particularly, in a case where a jam occurs at the time of second-side printing, where the jam occurrence position is in a fixing area, and where a cause of the jam occurrence is a fixing and discharging delay jam, the anti-jam mode for two-sided printing can be automatically increased by one level. Therefore, for example, an optimal value can be automatically set according to each printing even when a user does not know an optimal value for each printing enough to set the optimal value.

A second exemplary embodiment is described below. In the present exemplary embodiment, when the printing apparatus 103 confirms an operation for storing a sheet in a cassette (also referred to as a sheet storing unit, or a sheet cassette) upon jam occurrence, the CPU 301 changes a level of the set mode back to the mode at the beginning of printing, so that print processing can continue. Accordingly, a possibility of changing a type of sheet stored in the cassette can be considered. For example, the CPU 301 can prevent use of a thin-sheet setting mode, which is changed when a thin sheet is previously stored in a cassette, with respect to other types of sheets when the other types of sheets are stored. Moreover, when the printing apparatus 103 does not confirm the operation for storing a sheet in a sheet cassette, the CPU 301 can change a level of the set mode in a stepwise manner to continue the print processing. The CPU 301 sets one of modes designated by a PC 102 serving as an information processing apparatus as a mode at the beginning of the printing. Particularly, the CPU 301 sets the mode in the NVMEM 304. In the present exemplary embodiment, assume that execution of an operation for storing a sheet in a cassette is confirmed by checking whether the cassette is opened and then closed based on a change in a state of a switch, for example, disposed near the cassette.

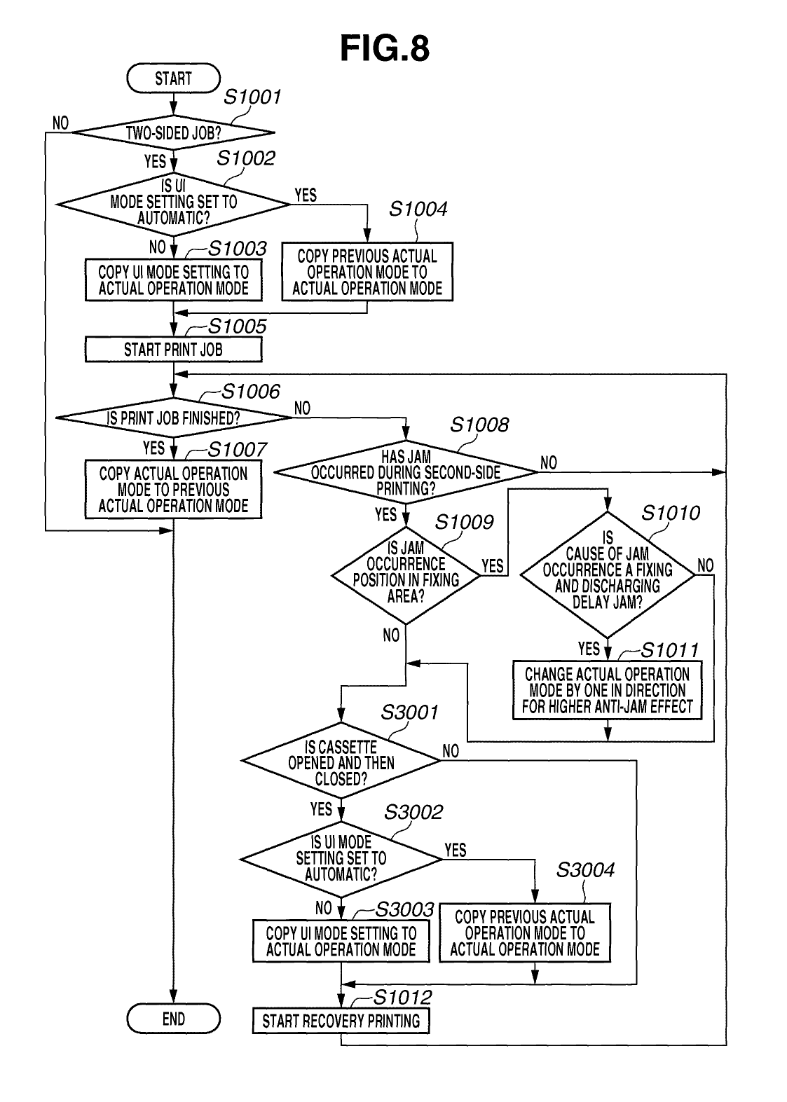

FIG. 8 is a flowchart illustrating a control method for the printing apparatus 103 according to the present exemplary embodiment. This flowchart illustrates an example procedure of print job processing. Each step is executed by the CPU 301 loading a control program into a RAM 303 to execute. This flow allows the printing apparatus 103 to automatically change an anti-jam mode setting for two-sided printing in a direction for higher anti-jam effect. This example procedure is addition of processing relating to an anti-jam mode setting to the step before execution of step S1012 in the flowchart illustrated in FIG. 6. This flow allows the printing apparatus 103 to automatically change an anti-jam mode setting for two-sided printing back to a setting at the beginning of a print job. Herein, processing from step S3001 to step S3004 is described. Descriptions of other steps are not repeated as described with reference to FIG. 6. In step S3001, the CPU 301 of the printing apparatus 103 determines whether a cassette for storing sheets is opened and then closed based on, for example, a change in a state of a switch (not illustrated) disposed near the cassette. If the CPU 301 determines that the cassette is not opened and then closed (NO in step S3001), then in step S1012, the CPU 301 causes the printing apparatus 103 to start recovery printing.

On the other hand, if the CPU 301 determines that the cassette storing the sheets is opened and then closed based on a change in a state of the switch (not illustrated) disposed near the cassette (YES in step S3001), the CPU 301 determines that there is a possibility that the user 101 has performed an operation for changing a sheet to be used for printing. Subsequently, in step S3002, the CPU 301 reads out the UI mode setting 501 stored in the NVMEM 304 and determines whether the UI mode setting 501 is set to automatic. If the CPU 301 determines that the user 101 has performed the operation for changing the sheet to be used for printing (YES in step S3002), then in step S3004, the CPU 301 changes an actual operation mode back to a setting at the beginning of the print job. Then operation proceeds to step S1012. Particularly, in step S3002, if the CPU 301 determines that the UI mode setting 501 is set to automatic, then in step S3004, the CPU 301 reads out the previous actual operation mode 503 stored in the NVMEM 304, and copies the previous actual operation mode 503 to the actual operation mode 502. Then, in step S1012, the CPU 301 causes the printing apparatus 103 to start the recovery printing.

On the other hand, if the CPU 301 determines that the UI mode setting 501 is not set to automatic (NO in step S3002), then in step S3003, the CPU 301 reads out the UI mode setting 501 stored in the NVMEM 304 and copies the UI mode setting 501 to the actual operation mode 502. Subsequently, in step S1012, the CPU 301 causes the printing apparatus 103 to start recovery printing.

According to the present exemplary embodiment, the printing apparatus 103 can control an anti-jam mode for two-sided printing to an optimal level according to each printing. Consequently, the user 101 does not need to concern about the mode setting since the printing apparatus 103 controls the anti-jam mode setting value being difficult to be determined by the user to an optimal value in an automatic manner. Therefore, the printing apparatus 103 according to the present exemplary embodiment can provide high usability.

In each of the first and second exemplary embodiments, step S1010 is described using an example case where the CPU 301 determines whether a cause of a jam occurrence is a fixing and discharging delay jam. However, exemplary embodiments of the present invention are not limited thereto. For example, if a jam occurrence position is determined to be in the fixing area in step S1009, the operation may proceed to step S1011. In such a case, even if a printing apparatus 103 does not have a sensor for detecting a fixing and discharging delay jam as a cause of a jam occurrence, the printing apparatus 103 can appropriately set an anti-jam mode. Moreover, in each of the first and second exemplary embodiments, in a case where a jam occurrence at the time of second-side printing is detected, where a jam occurrence position is in a fixing area, and where a cause of the jam occurrence is determined as a fixing and discharging delay jam, the actual operation mode 502 is changed in step S1011. However, exemplary embodiments of the present invention are not limited thereto. The CPU 301 may control the processing as follows. The CPU 301 may manage each of the sheets conveyed in the sheet conveyance path by determining whether a sheet is to undergo first-side printing or second-side printing based on a signal received from the sensors disposed on the sheet conveyance path. Then, if the sheet having passed the transfer nip for second-side printing is jammed in the fixing area, and a cause of the jam occurrence is determined to be a fixing and discharging delay jam, the CPU 301 may change the actual operation mode 502 in step S1011.

### Other Embodiments

In a case where a jam occurs while printing using a thin sheet is executed, the CPU 301 may change the actual operation mode 502 regardless to a position of the jam. In other words, the CPU 301 may reduce a transfer bias or a temperature of the fixing device. The CPU 301 reduces the transfer bias or the temperature of the fixing device when the jam occurs in first-side printing or when the jam occurs second-side printing. On the other hand, in a case where a jam occurs while printing using a normal sheet is executed, the CPU 301 does not change the actual operation mode 502 regardless to the position of the jam.

Aspects of the present invention can also be realized by a computer of a system or apparatus (or devices such as a CPU or a micro-processing unit (MPU) which may also be referred to as a microprocessor) that reads out and executes a program recorded on a memory device to perform the functions of the one or more of above-described embodiment(s) of the present invention, and by a method, the steps of which are performed by a computer of a system or apparatus by, for example, reading out and executing a program recorded on a memory device to perform the functions of one or more of the above-described embodiment(s) of the present invention. The program can be provided to the computer, for example, via a network or from a recording medium of various types serving as the memory device (e.g., non-transitory computer-readable medium). The computer-readable medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-018097 filed Jan. 31, 2012, which is hereby incorporated by reference herein in its entirety.

What is claimed is:

1. A printing apparatus configured to print an image on a sheet, the printing apparatus comprising:
a fixing unit configured to fix the image on the sheet at a first fixing temperature;
a first determination unit configured to determine whether a sheet jam caused by the fixing unit has occurred; and
a control unit configured to control a temperature of the fixing unit such that the temperature is reduced from the first fixing temperature to a second fixing temperature lower than the first fixing temperature, when the first determination unit determines that the sheet jam caused by the fixing unit has occurred.

2. The printing apparatus according to claim 1, further comprising a transfer unit configured to transfer the image to the sheet by applying a first transfer bias,
wherein, when the first determination unit determines that the sheet jam caused by the fixing unit has occurred, the control unit controls a temperature of the fixing unit such that the temperature is reduced from the first fixing temperature to the second fixing temperature, and a transfer bias of the transfer unit such that the transfer bias is reduced from the first transfer bias to a second transfer bias having a lower bias value than the first transfer bias.

3. The printing apparatus according to claim 1, further comprising a second determination unit configured to determine whether the sheet jam caused by the fixing unit has occurred at the time of printing of an image on a second side of the sheet,
wherein, when the first determination unit determines that the sheet jam caused by the fixing unit has occurred, and the second determination unit determines that the sheet jam caused by the fixing unit has occurred, the control unit controls a temperature of the fixing unit such that the temperature is reduced from the first fixing temperature to the second fixing temperature.

4. The printing apparatus according to claim 1, wherein, when a power source of the printing apparatus is shut down after the temperature of the fixing unit is reduced from the first fixing temperature to the second fixing temperature, the control unit changes the temperature of the fixing unit from the second fixing temperature to the first fixing temperature.

5. The printing apparatus according to claim 1, further comprising a specifying unit configured to specify the first fixing temperature or the second fixing temperature as the temperature of the fixing unit.

6. A method for controlling a printing apparatus configured to print an image on a sheet, the method comprising:
fixing the image on the sheet at a first fixing temperature by a fixing unit;
determining whether a sheet jam caused by the fixing unit has occurred; and
controlling a temperature of the fixing unit such that the temperature is reduced from the first fixing temperature to a second fixing temperature lower than the first fixing temperature, when the sheet jam caused by the fixing unit is determined to have occurred.

7. A computer-readable storage medium storing a computer program that causes a printing apparatus to print an image on a sheet, the computer program comprising:
a code to cause a fixing unit to fix the image on the sheet at a first fixing temperature;
a code to determine whether a sheet jam caused by the fixing unit has occurred; and
a code to control a temperature of the fixing unit such that the temperature is reduced from the first fixing temperature to a second fixing temperature lower than the first fixing temperature, when the sheet jam caused by the fixing unit is determined to have occurred.
